(19) United States
(12) Patent Application Publication
(10) Pub. No.: US 2016/0183485 A1
(43) Pub. Date: Jun. 30, 2016

(54) POT WITH A WATER RESERVE FOR A PLANT

(71) Applicant: PARROT, Paris (FR)

(72) Inventors: Arthur Petry, Paris (FR); Vincent Bihler, Paris (FR)

(21) Appl. No.: 14/979,865

(22) Filed: Dec. 28, 2015

(30) Foreign Application Priority Data
Dec. 29, 2014 (FR) 14 63363

(51) Int. Cl. A01G 27/00; A01G 9/02

(52) U.S. Cl. CPC A01G 27/005; A01G 9/02

(57) ABSTRACT

The pot has a container for the substrate of the plant, a container for a water reserve, and means for bringing water from the water reserve to the substrate. It comprises: an external container (300) closed in lower part and open in upper part; an internal container (100, 200) defining a cavity (C1) for the substrate, the external container and the internal container defining between each other a cavity (C4) for a water reserve and being able to be fitted into each other and disconnected from each other; a pumping means (P) fastened to the internal container with an inlet exposed to the water reserve, and connected to a pumping control circuit (CC); and means (500, 501, 502) for fluidic connection between an outlet of the pumping means and at least one irrigation orifice (127) located in upper part of the internal container. The irrigation is performed by the top, and the pot is easy to maintain and clean.

The present invention generally relates to the pots and other containers for plants, and more precisely the pots equipped with soil irrigation or humidification devices.

Pots of the “Riviera” type (registered trademark) are known for long, which comprise a container provided in lower part with a space forming water reserve. An intermediate horizontal plate separates the substrate from this space, and fibrous elements in contact with the substrate dip in the water reserve and convey the water up to the soil by capillarity. A duct is moreover provided over the height of the pot to fill the water reserve from the upper region of the pot.

This known principle of irrigation allows to keep the soil humid. However, it is extremely dependent on the quality of the substrate, and often gives rise to an excess of humidity in the lower part of the substrate, and to a lack of humidity in the upper part of the substrate.

This is generally harmful for the health of the plant, inducing phenomena such as root deterioration, etc.

Furthermore, such pots are extremely difficult to clean, generally requiring the plant to be taken out from the pot then put back into the pot, which is problematic in particular for the house plants (risks of dirt, humidity of the substrate, etc.).

The present invention aims to improve the pots for plants with a water reserve and to propose a pot that:
ensures an irrigation that is more favourable to the plant health;
is easy to maintain and clean;
protects easily the technical components of the pot (irrigation pump and circuit, control circuit, battery, sensors, etc.); and
allows to easily accede to the whole of these technical components to easily intervene in case of problem.

The DE 297 18 416 U1 discloses a pot with a water reserve of the type having a container for the substrate of the plant, a container for a water reserve, and means for bringing water from the water reserve to the substrate. More precisely, this known pot comprises:
an external container closed in lower part and open in upper part;
an internal container defining a cavity for the substrate, the external container and the internal container defining between them a cavity for a water reserve and being able to be fitted into each other and disconnected from each other;
a pumping means fastened to the internal container and an inlet of which is exposed to the water reserve, said pumping means being connected to a pumping control circuit; and
means for fluidic connection between an outlet of the pumping means and at least one irrigation orifice located in upper part of the internal container.

Characteristically of the invention, the internal container comprises two elements fitted into each other. The internal element of the internal container defines at least one cavity of the pumping means and the control circuit, and the external element of the internal container is adapted to close at least partially said cavity(ies).

Some preferred but non-limitative aspects of the pot according to the invention comprise the following characteristics, taken individually or in any technical combination that the one skilled in the art will comprehend as being technically compatible:
the pot also comprises a dish into which the external container is adapted to be fitted;
said cavity for a water reserve is of generally annular cross section;
an internal element of the internal container comprises an upper part forming the cavity for the substrate, and a lower part housing the pumping means and the associated control means;
the pot comprises a set of irrigation orifices distributed at the internal periphery of the internal container;
the irrigation orifices extend from an annular cavity defined jointly by at least two elements of the pot;
the fluidic connection means comprise at least one tubular duct extending between the outlet of the pumping means and the irrigation orifices via a chimney protruding into the cavity for the substrate;
the pot comprises at least one channel for evacuating an excess of water in the substrate, extending between the cavity for the substrate and the cavity for the water reserve.

An exemplary embodiment of the invention will now be described, with reference to the appended drawings, in which the same references denote identical or functionally similar elements throughout the figures.

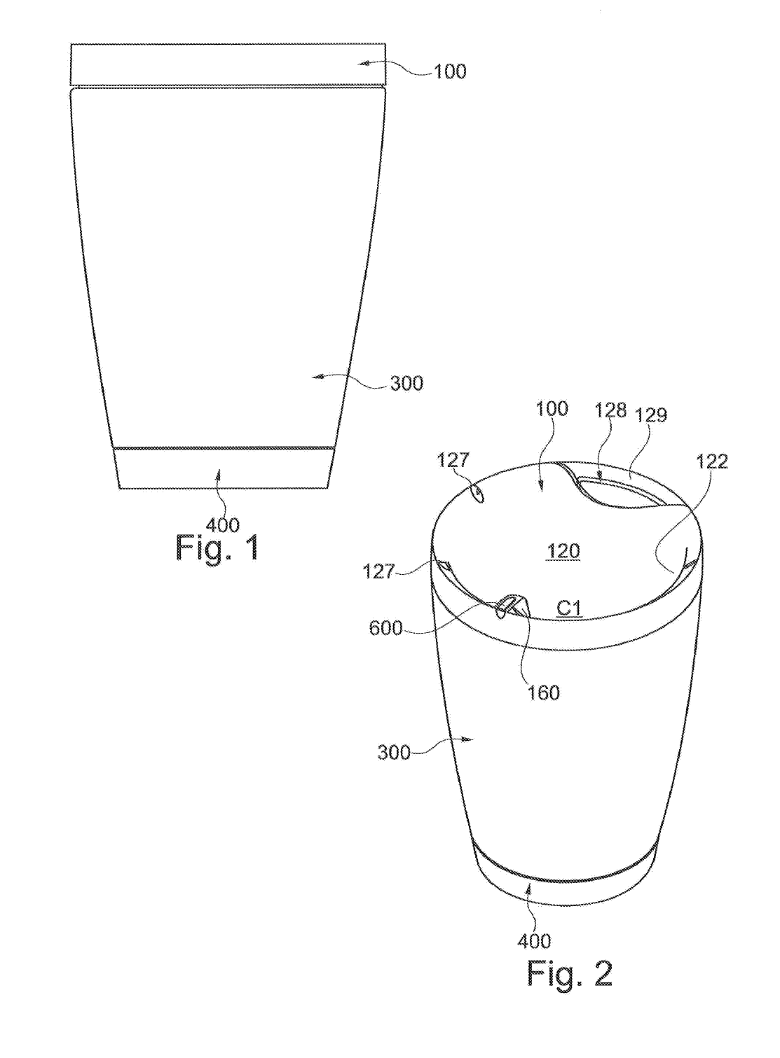

FIG. 1 is an elevation side view of a pot with a water reserve according to the invention.

FIG. 2 is a perspective view of the pot of FIG. 1.

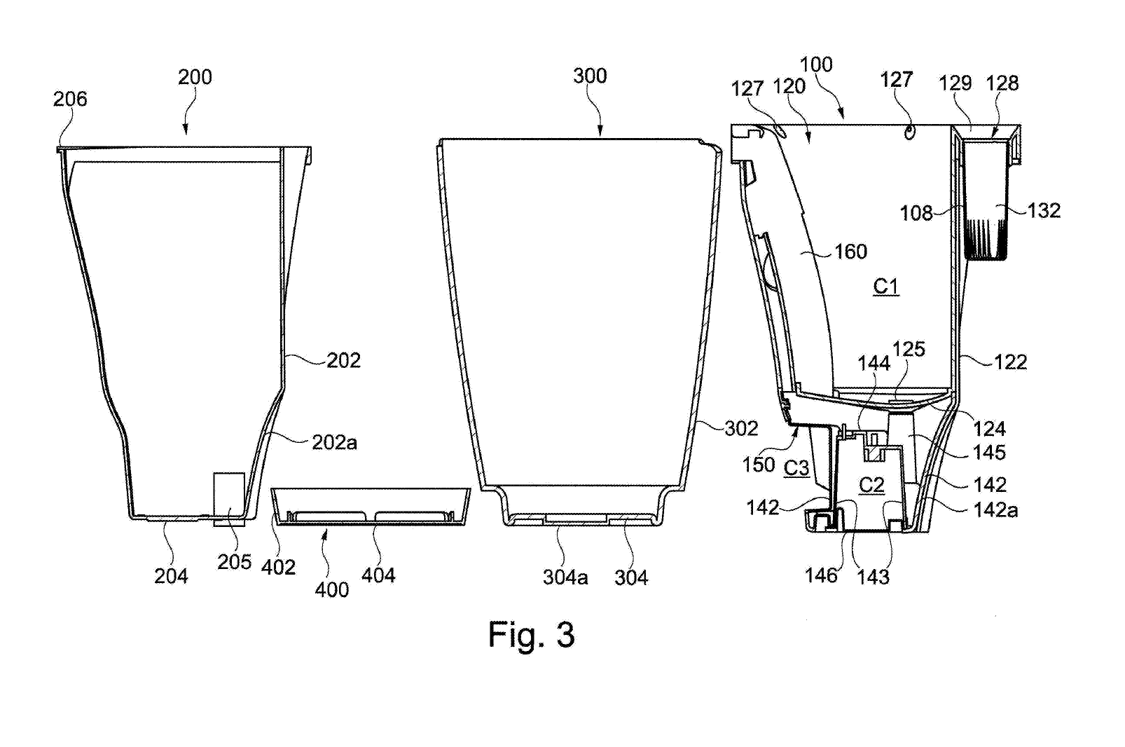

FIG. 3 is a generally axial vertical sectional view of the elements constituting the pot, separated from each other.

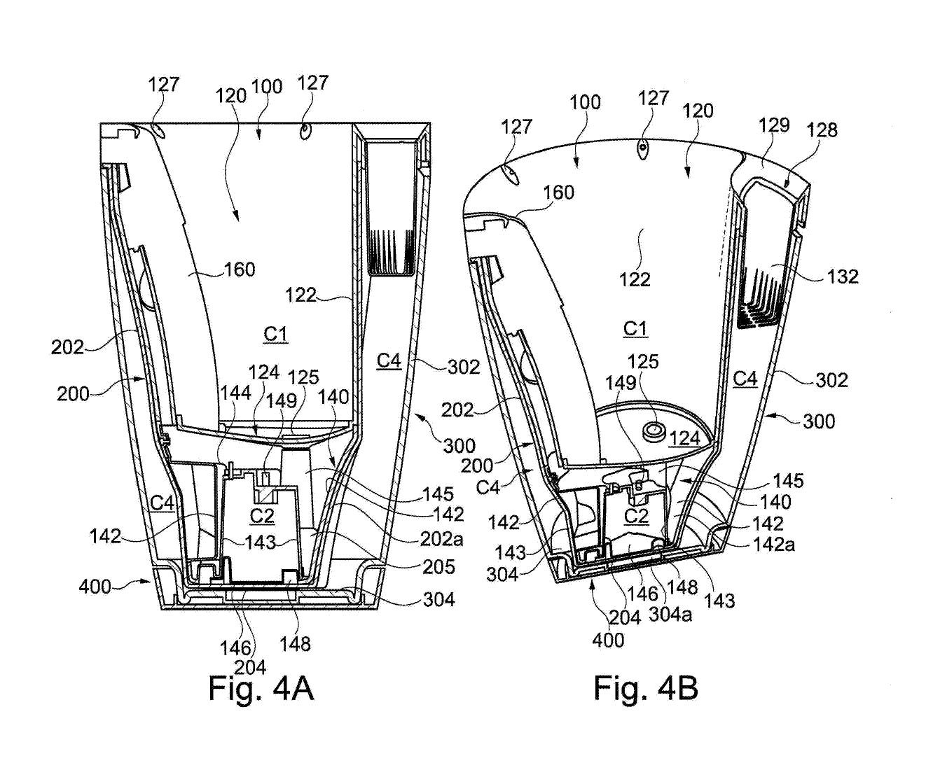

FIG. 4A is a generally axial vertical sectional view of the elements constituting the pot, assembled with each other.

FIG. 4B is a perspective view of the sectional view of FIG. 4A.

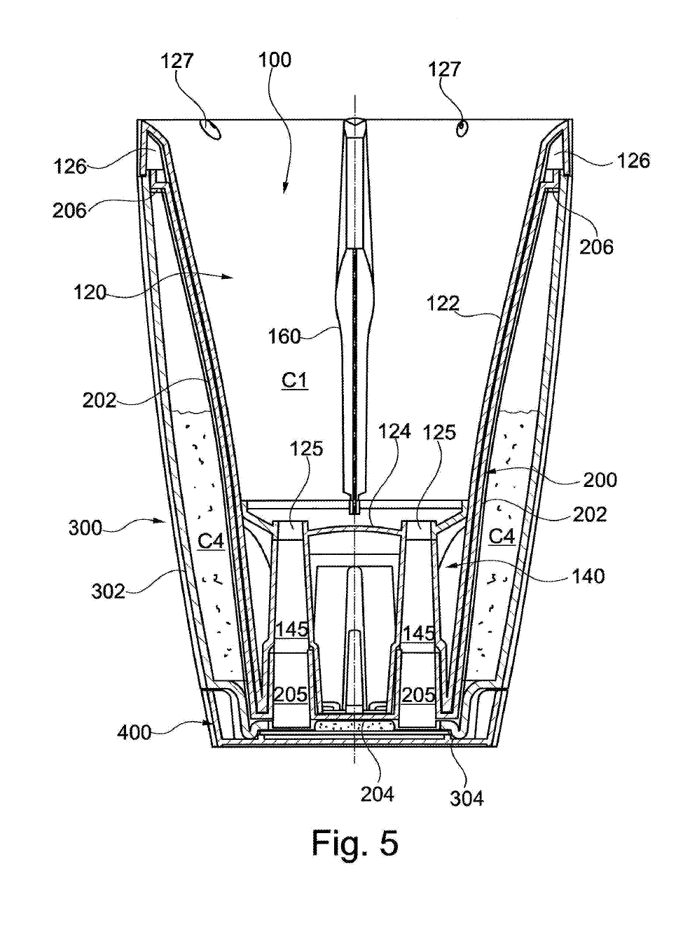

FIG. 5 is a vertical sectional view according to a plane orthogonal to the section plane of FIGS. 4A and 4B.

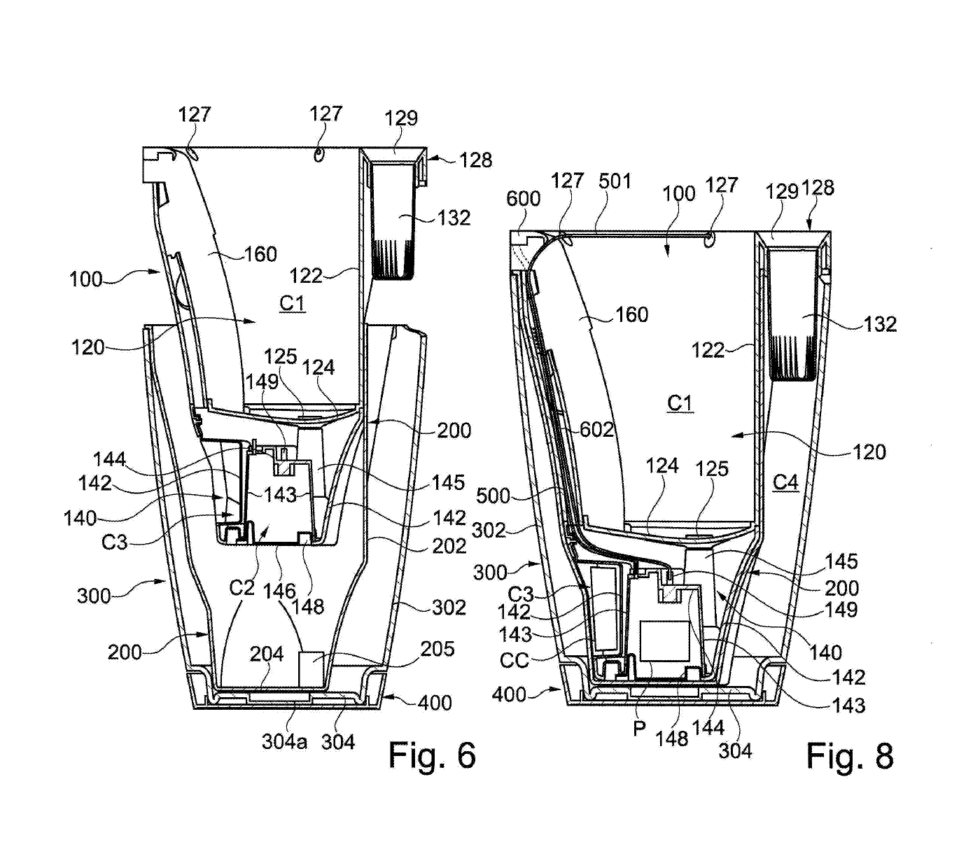

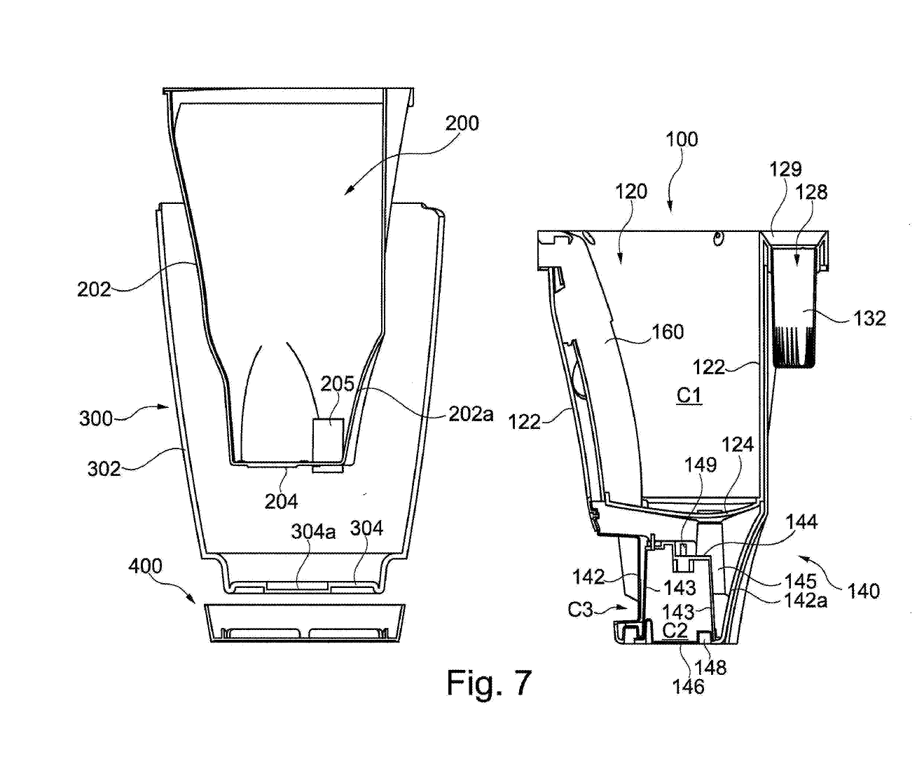

FIGS. 6 and 7 are generally axial vertical sectional view of the pot with its elements partially separated from each other and partially fitted into each other, in two different situations.

FIG. 8 is a view similar to that of FIG. 4A, illustrating water conveyance means.

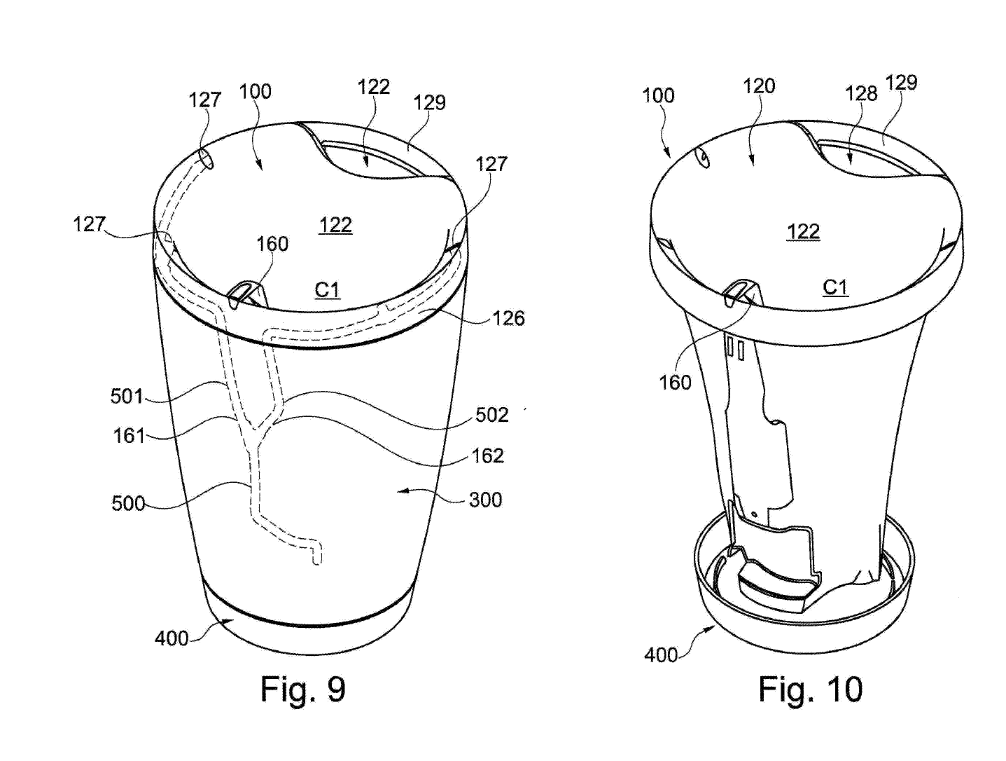

FIG. 9 is a perspective view, in partial transparency, also illustrating the water conveyance means.

FIG. 10 is a perspective view of the pot, an external element of the latter being not visible.

With reference to the drawings, a pot for a plant, in particular an indoor pot plant or flower, mainly comprises four elements:
a first and a second elements 100 and 200 are adapted to be fitted into each other to form a container for a substrate (soil, sand, potting soil, etc., in various possible mixtures) that is not shown;
a third element 300 is intended to receive by fitting from the top the first and second elements 100, 200;
a dish 400 that supports all the elements 100, 200, 300.

These elements are preferably all manufactured from injected plastic material, but any other material compatible with their shapes and functions is of course possible.

The first element 100 or internal element comprises a main upper part 120 including a lateral wall 122, generally flared upward, and a bottom wall 124.

These two walls define a cavity C1 for the substrate of the plant.

The first element 100 also comprises a lower part 140 that is fixed, for example by clipsage, under the bottom wall 124.

This part 140 has an external vertical wall 142, an internal vertical wall 143 closed by a top wall 144 of complex shape, and a lower opening closed by a cap 146, the walls 143, 144 and the cap 146 defining together a cavity C2 intended to receive a pump P, not shown in most of the figures but schematically illustrated in FIG. 8, whose role and operation will be explained hereinafter.

FIG. 3 more particularly illustrates a water intake 148, incorporating if need be a strainer, formed in the cap 146 and located in the lower region of the cavity C2, allowing the supply of the pump, and a tip 149 formed in the top wall 144 (bottom of the cavity C2) connected to the outlet of the pump and connected to an irrigation tube as will be seen in detail hereinafter.

In the bottom wall 124 of the upper part 120 of the first element 100 are defined two openings 125 that communicate in a water-tight manner with two generally vertical channels 145 formed by the lower part 140, these channels 145 covering substantially the whole vertical extent of the lower part 140 and being open at their upper and lower ends.

A membrane that is permeable to water but that does not let the substrate (not illustrated) through, for example made of felt, nonwoven, plastic or metal grid, etc., is placed in the openings 125 of the bottom 124 to avoid that the substrate can fall into the channels 145.

The lower part of the element 100 also comprises a lateral cavity C3 defined by a local recess of the wall 142 and intended to house a battery, an electronic control circuit, etc., these components being not shown in most of the figures and being schematically illustrated (reference CC) in FIG. 8.

The element 100 moreover comprises a chimney part 160 extending locally in a general vertical direction along the lateral wall 122, on the inner side of the latter.

This chimney has a generally U-shaped horizontal section, closed by the adjacent area of the wall 122, by being fixed to the latter by clipsage, bonding, ultrasound welding, etc.

This chimney has for function to convey the water pumped by the pump P up to the upper region of the upper part 120 of the element 100 by means that will be described hereinafter.

This upper region comprises a peripheral channel 126 delimited, as shown in particular in FIG. 5, by the upper region of the wall 122, by an external edge 130 extending generally downward from the top of said wall 122, and finally by a cooperation between upper fitting arrangements formed in the upper region of the element 200 and in the upper region of the element 300. These arrangements include in particular a flange 206 protruding outward from the top of the element 200. This peripheral channel 126 opens into the upper region of the wall 122 forming the cavity C1 via a set of orifices 127.

Finally, the upper part 120 of the first element 100 has also, at a recess of the cavity C1 (see FIG. 1), a filling passage 128 separated from said cavity while being integrated to the generally circular contour of the pot, and intended to receive, preferably removably, a filter basket 132, the passage 128 and the filter basket 132 allowing a user to fill a water reserve of the pot, as will be described hereinafter.

This passage 128, closed over itself, has an upper part with inclined faces 129 forming a funnel.

A second element 200 of the pot or intermediate element, which has substantially the same contours as the parts 120 and 140 of the first element, once assembled together, and includes a lateral wall 202 and a lower wall 204.

Furthermore, two vertical channels 205, open at the top and the bottom, are formed in the lower wall 204 and arranged in alignment with the channels 145 of the lower part 140 of the element 100. As shown in particular in FIG. 5, channels 205 fit into an enlarged base of the channels 145, in a tight manner (by plastic-to-plastic contact or through a specific gasket), the base of the cavity C1 hence communicating with the bottom of the element 200 via the above-mentioned membranes.

The first element 100 is tightly fitted into the second element 200, with shape cooperation as illustrated in the figures, the second element 200 having for main functions to protect the different members received on the first element 100 and to define a generally smooth internal wall for a water reserve of generally annular cross section, as will be described hereinafter.

Advantageously, the shape cooperation between the elements 100 and 200 includes an angular indexing provided in particular by a localised recess 202a in the lateral wall 200 of the second element, which cooperates with a mating recess 142a formed locally in the lateral wall 142 of the lower part 140 of the element 100.

The pot comprises a third element 300 or external element that has a general shape of revolution, with a flared lateral wall 302 and a bottom wall 304.

This element is intended to receive, here again by fitting, the unit formed of the elements 100, 200, hence delimiting an annular cavity C4 forming a water reserve.

This cavity C4 opens to the outside in the upper part via the filter basket 130, which engages downward into said cavity, hence allowing the filling of the reserve by the top.

The bottom wall 304 is fully continuous to hold the water in the cavity C4 with no risk of leakage. The lower openings of the channels 145 open into the bottom region of this cavity, immediately under the element 200, at a downward recess 304a formed in the bottom wall 304.

Moreover, it is observed that the water intake 148 for the supply of the pump housed in the cavity C2 is also located at the bottom of the water reserve.

The pot further comprises a dish 400 having a flared lateral wall 402 and a bottom 404, this dish being intended to receive by fitting the base of the element 300, itself housing the elements 100 and 200.

With reference now to FIGS. 8 and 9, the circuit of irrigation of the substrate contained in the cavity C1 of the pot is shown.

A flexible or semi-stiff tubular duct 500 is connected at its lower end to the tip 140 that belongs to the lower part 140 of the element 100 and that is connected to the outlet of the pump.

This duct extends from there under the bottom 124 of the upper part towards the cavity C3 defined by the chimney 160. At an intermediate height of the chimney 160, it is divided into two sections 501, 502 that go out from the chimney by passing through two notches 161, 162 formed laterally in the latter and that are connected in a water-tight manner to the irrigation orifices 127 formed in the upper part 120 of the element 100 about the cavity C1.

The pot may further be equipped with the following complementary elements:
an overflow system allowing an excess of water to be evacuated to the dish 400;
an automated mechanical valve located at the water intake strainer and allowing to avoid that the water contained in the pump flows when the elements 100, 200 are extracted from the element 300;
sensors (light sensor, sensor of humidity in the substrate) allowing to automatically control the irrigation as a function of predefined criteria; it has hence be illustrated in FIG. 8 a photo-electric sensor 600 arranged at the top of the chimney 160 and connected to the control circuitry via a cable 602 passing by this chimney and through the bottom wall 144 of the part 140 of the element 100;
a sensor of water level in the tank to warn about the necessity to fill the latter.

The assembly and the use of the pot according to the invention will now be described, with reference to the different figures, which clearly show how the different elements are assembled to each other by very simple fitting operations.

The extraction of the elements 100, 200 from the inside of the element 300 allows to easily clean the tank.

Furthermore, extracting the element 100 from the element 200 allows an easy access to all the technical components of the pot: pump and irrigation circuit, control circuit, sensors, etc., to easily intervene in case of problem.

Once all the elements assembled together, the tank formed by the cavity C3 is filled via the filter basket 132, up to a maximum level that may for example be indicated inside the filter basket.

From this instant, the strainer or other water intake is immersed in the water reserve. The electronic control card then operates the pump, according to the irrigation strategy defined, for example from several times a day to once a week according to the type of plant (the control circuit being advantageously programmable for that purpose). The water is conveyed via the tubular ducts 500, 501, 502 up to the orifices 127, to flow into the substrate.

In the case where an excess of water is present in the substrate, this water flows through the vertical channels 145, 205 via the openings 125, to go back to the tank (or, as a variant, to the dish 400).

1. A pot with a water reserve for a plant, of the type having a container for the substrate of the plant, a container for a water reserve, and means for bringing the water from the water reserve to the substrate, this pot comprising:
an external container (300) closed in lower part and open in upper part;
an internal container (100, 200) defining a cavity (C1) for the substrate, the external container and the internal container defining between each other a cavity (C4) for a water reserve and being able to be fitted into each other and disconnected from each other;
a pumping means (P) fastened to the internal container and an inlet of which is exposed to the water reserve, said pumping means being connected to a pumping control circuit (CC); and
means (500, 501, 502) for fluidic connection between an outlet of the pumping means and at least one irrigation orifice (127) located in upper part of the internal container,
characterized in that the internal container comprises two elements (100, 200) fitted into each other, in that the internal element (100) of the internal container (100, 200) defines at least one cavity (C2, C3) of the pumping means (P) and the control circuit (CC), and in that the external element (200) of the internal container is adapted to close at least partially said cavity(ies).

2. The pot of claim 1, also comprising a dish (400) into which the external container (300) is adapted to be fitted.

3. The pot of claim 1, wherein said cavity (C4) for a water reserve is of generally annular cross section.

4. The pot of claim 1, wherein an internal element (100) of the internal container comprises an upper part (120) forming the cavity (C1) for the substrate, and a lower part (140) housing the pumping means (P) and the associated control means (CC).

5. The pot of claim 4, comprising a set of irrigation orifices (127) distributed at the internal periphery of the internal container (100, 200).

6. The pot of claim 5, wherein the irrigation orifices (127) extend from an annular cavity (126) defined jointly by at least two elements (100, 200, 300) of the pot.

7. The pot of claim 6, wherein the fluidic connection means comprise at least one tubular duct (500, 501, 502) extending between the outlet of the pumping means (P) and the irrigation orifices (127) via a chimney (160) protruding into the cavity (C1) for the substrate.

8. The pot of claim 1, comprising at least one channel (145, 205) for evacuating an excess of water in the substrate, extending between the cavity (C1) for the substrate and the cavity (C4) for the water reserve.
